(19) United States
(12) Patent Application Publication
(10) Pub. No.: US 2014/0179346 A1
(43) Pub. Date: Jun. 26, 2014

(54) PORTABLE COMMUNICATION DEVICE

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: Si-Quan CHEN, New Taipei (TW); Xiu-Ping LV, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/868,114

(22) Filed: Apr. 23, 2013

(30) Foreign Application Priority Data
Dec. 26, 2012 (CN) 2012105735984

(51) Int. Cl. H04W 4/02

(52) U.S. Cl. CPC H04W 4/021
USPC 455/456.1

(57) ABSTRACT

A portable communication device includes a processor, a communication unit to communicate with a server, and a locating unit to determine a location of the communication device. The processor is operable to: determine whether one application belongs to a restricted category when a input unit receives a user input to start the application; obtain a list associated with the location from the storage unit, if the application belongs to a restricted category; and start the application if a name of the application is included in the list, or otherwise ignore the user input.

### BACKGROUND

1. Technical Field

The present disclosure relates to portable communication devices, and particularly to a portable communication device capable of controlling functionality depending on location of the device.

2. Description of Related Art

Most portable phones have a digital camera and/or camcorder to record still or video pictures. The ability of users to easily record photographs and/or video on portable devices presents a security challenge for businesses, corporate facilities, or other locations where picture taking is strictly prohibited or otherwise limited. These types of locations may include museums, factories, government facilities, or office buildings. For many of these locations, the security risk is that portable device users can easily copy and misappropriate trade secrets or other proprietary information. Therefore, what is needed is an electronic device to resolve the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic block diagram of one embodiment of an electronic device.

FIG. 2 is a schematic diagram showing applications stored in a storage unit of the electronic device of FIG. 1.

### DETAILED DESCRIPTION

Embodiments of the present disclosure will be described with reference to the accompanying drawings.

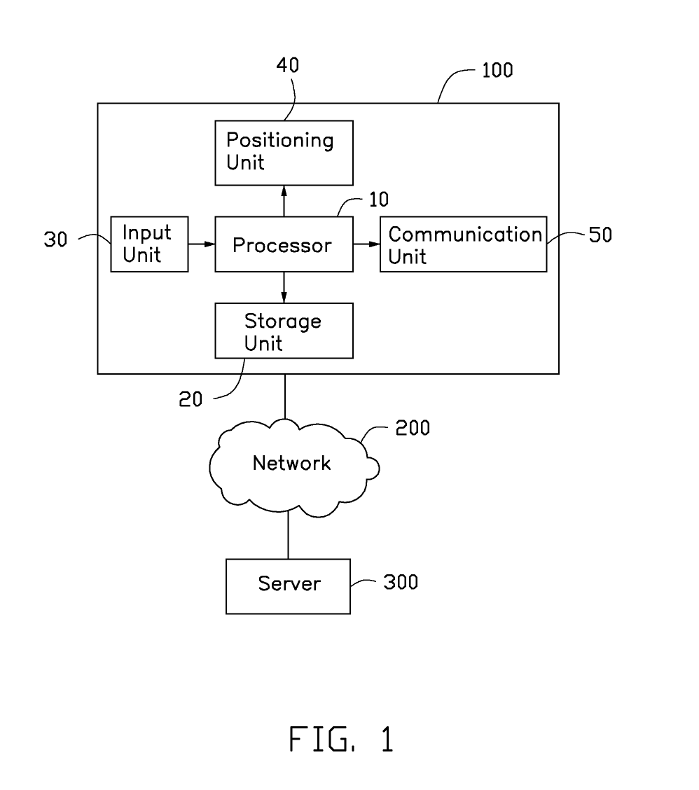

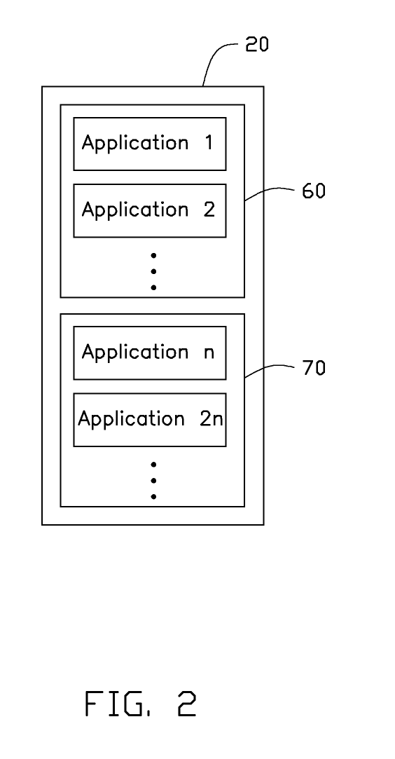

Referring to FIGS. 1 and 2, a portable communication device 100 includes a processor 10, a storage unit 20, an input unit 30, a locating unit 40, and a communication unit 50. The communication device 100 can communicate with a server 300 via a network 200.

The storage unit 20 stores a number of applications that are executable by the processor 10. In the embodiment, the applications are classified into two categories: a general category 60 and a restricted category 70. The portable communication device 100 can operate in a normal mode or in a work mode. When the communication device 100 is set to operate in the work mode, applications in the restricted category 70 are prohibited from running in certain locations, while applications in the general category 60 have no such limitations. For example, when the communication device 100 is a cellular phone, a camera application may be classified as belonging to the restricted category 70, and a phone call application may be classified as belonging to the general category 60. As a result, a user cannot start the camera application in the preset locations (e.g., a laboratory), but can make a phone call by starting the phone call application. All of the applications can run freely in any locations when the portable communication device 100 is set to run in the normal mode.

In the embodiment, the storage unit 20 stores a table defining which of the applications belong to the general category 60 and which of the applications belong to the restricted category 70. The server 300 delivers periodically or in response to a request from the portable communication device 100 updates for the table. The processor 10 determines which of the applications belongs to the general category 60 and which of the applications belongs to the restricted category 70 according to the table.

In the embodiment, the storage unit 20 further stores lists, each list defining an area and one or more applications that are allowed to run in the area. The server 300 may deliver periodically or in response to a request from the portable communication device 100 updates for the lists. The processor 10 determines which applications are allowed to run at the current geographical location of the portable communication device 100 according to the lists.

The input unit 30 receives a user input. The locating unit 40 determines a geographic location of the portable communication device 100. In one embodiment, the locating unit 40 can receive signals from global locating system satellites and determine a geographic location of the portable communication device 100 according to the received signals. The communication unit 50 can communicate with the server 300 via the network 200.

In the embodiment, when the communication device 100 is set to operate in the work mode and the input unit 30 receives a user input to start an application, the processor 10 determines whether the application belongs to the restricted category 70. If so, the processor 10 searches for a list corresponding to the current geographical location of the portable communication device 100 in the storage unit 20. If the list corresponding to the current geographical location is not available in the storage unit 20, the processor 10 sends a request via the communication unit 50 to the server 300. The server 300 then sends a list corresponding to the current location of the portable communication device 100. If the name of the application is included in the list, the processor 10 starts the application; otherwise, the processor 10 ignores the user input and does not start the application.

In the embodiment, the processor 10 monitors the geographical location of the portable communication device 100. As long as the portable communication device 100 is located within an area defined in one of the lists, the applications belonging to the restricted category 70 whose names are included in the list can be started without sending a request to the server 300. When the portable communication device 100 moves to a new location outside of the area defined in any of the lists, the processor 10 terminates all currently running restricted applications.

In an alternative embodiment, the storage unit 20 may store a session that includes an area and names of the applications that are allowed to run in the area. The processor 10 determines whether to start an application belonging to a restricted category according to the session.

In an alternative embodiment, each list stored in the storage unit 20 may be valid for a predetermined time period and the processor 10 sends a request via the communication unit 50 for a new list once any stored list becomes invalid.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A portable communication device comprising:
a processor;
an input unit configured to receive a user input;
a storage unit configured to store a plurality of applications executable by the processor;
a communication unit configured to communicate with a server;
a locating unit configured to determine a geographic location of the portable communication device;
wherein the processor is operable to:
determine whether one of the plurality of applications belongs to a restricted category when the input unit receives a user input to start the one of the plurality of applications;
obtain a list associated with the geographic location from the storage unit, if the one of the plurality of applications belongs to a restricted category;
start the one of the plurality of applications if a name of the one of the plurality of applications is included in the list, otherwise ignore the user input.

2. The portable communication device according to claim 1, wherein the processor is configured to monitor the geographical location of the portable communication device, the list is configured to define an area and one or more of the plurality of applications that are allowed to run in the area, the processor is further configured to terminate currently running applications that belong to the restricted category.

3. The portable communication device according to claim 1, wherein the locating unit is operable to communicate with global locating system satellites to determine the geographic location of the portable communication device.

4. The portable communication device according to claim 1, wherein each list stored in the storage unit is valid in a predetermined time period and the processor sends a request via the communication unit to the server for a new list once the list becomes invalid.
